(19) United States
(12) Patent Application Publication
(10) Pub. No.: US 2023/0175706 A1
(43) Pub. Date: Jun. 8, 2023

(54) INTEGRATED SYSTEMS FOR GENERATING THERMAL ENERGY AND HYDROGEN

(71) Applicant: Ohmium International, Inc., Incline Village, NV (US)

(72) Inventor: Arne Ballantine, Incline Village, NV (US)

(21) Appl. No.: 18/077,057

(22) Filed: Dec. 7, 2022

Related U.S. Application Data
(60) Provisional application No. 63/286,808, filed on Dec. 7, 2021.

(51) Int. Cl. F24D 18/00; F24S 10/00

(52) U.S. Cl. CPC F24D 18/00; F24S 10/00

(57) ABSTRACT

The present disclosure provides systems for a continuous generation of a heat supply from renewable energy. The systems generally comprise a hydrogen generator to be electrically connected to a photovoltaic panel and to be thermally connected to a thermal loop, the thermal loop including a solar thermal system, a heat load, and a radiator.

### CROSS-REFERENCE TO RELATED APPLICATIONS

This application claims priority to U.S. Application No. 63/286,808 entitled “HEAT GENERATOR VIA SOLAR THERMAL PLUS HYDROGEN GENERATION OR FUEL CELL GENERATION WITH HEAT CAPTURE AND THERMAL GENERATION” field Dec. 7, 2021, the entirety of which is incorporated by reference herein.

### FIELD OF THE DISCLOSURE

The present disclosure relates to systems for a continuous generation of a heat supply from renewable energy comprising: a hydrogen generator; a photovoltaic panel electrically connected to the hydrogen generator; and a thermal loop. The systems relate to the field of chemistry and chemical engineering.

### BACKGROUND OF THE INVENTION

Continuous heat generation (e.g., 24 hours a day, 7 days a week) in useful loads is difficult when using only renewable energy sources. Generally, to provide this continuous heat generation in useful loads, the renewable energy sources are paired with non-renewable energy sources such as fossil fuels (such as wood, coal, propane gas, and oil) and utility companies (such as electric, or natural gas companies) to provide the additional heat generation needed during the time when renewable energy sources are incapable of providing sufficient energy to maintain the required heat generation in useful loads.

The use of non-renewable energy sources has an additional effect regarding the environment. The use of non-renewable energy sources has been shown to not only increase carbon dioxide in the atmosphere but also increases the temperature of the atmosphere.

What is needed are integrated systems for generating useful continuous heat supply using renewable energy sources.

### SUMMARY OF THE INVENTION

Provided herein are systems for generating a continuous heat supply from renewable energy. The systems generally comprise a hydrogen generator to be electrically connected to a photovoltaic panel and to be thermally connected to a thermal loop. The thermal loop includes a solar thermal system to generate heat, a heat load, and a radiator to release heat. In some aspects, the thermal loop further comprises a reactor. In some examples, the reactor is a catalytic combustion reactor. In some aspects, the thermal loop further comprises a pump. In some examples, the pump is a heat pump. In particular examples, the heat pump is electrically connected to the photovoltaic panel.

In preferred embodiments, the solar thermal system, the heat load, and the radiator are in thermal communication with one another via a heat exchange fluid. In some aspects, the heat exchange fluid is a molten salt. In other aspects, the heat exchange fluid is glycol. In additional embodiments, the solar thermal system is configured to operate as a radiator when it is not generating heat.

In some embodiments, the systems further comprise a hydrogen storage system fluidly connected to the hydrogen generator. In some additional embodiments, the systems further comprise a hydrogen fuel cell electrically connected to the hydrogen generator. In further embodiments, the hydrogen generator comprises a proton exchange membrane (PEM) electrolyzer. In still further embodiments, the systems further comprise an electricity storage system electrically connected to the photovoltaic panel. In some embodiments, the systems further comprise a DC/DC rectifier electrically connected to the photovoltaic panel and the hydrogen generator.

Further provided herein are methods for producing a continuous heat supply from renewable energy. The methods generally comprise producing thermal energy via a solar thermal system, generating hydrogen in a hydrogen generator, producing thermal energy by combusting the generated hydrogen, and providing the producing thermal energy to a heat load. In some embodiments, the thermal energy produced by the solar thermal system is only produced when sunlight is received by the solar thermal system. In some additional embodiments, the thermal energy produced by combustion of the generated hydrogen is only produced when sunlight is not received by the system. In preferred embodiments, the thermal energy is provided to the heat load via a heat exchange fluid. In some embodiments, the methods further comprise releasing the produced thermal energy via a radiator or via the solar thermal system when the system is not receiving sunlight.

Other features and iterations of the invention are described in more detail below.

### BRIEF DESCRIPTION OF THE FIGURES

FIG. 1A depicts a block diagram for the integrated system for generating continuous heat when the system is receiving sunlight. Generally, the heat load is produced from the solar thermal system and the hydrogen generator. The hydrogen generator is activated by the electrical output of least one photovoltaic panel and the DC/DC rectifier to generate hydrogen gas from water. The hydrogen gas is stored in a hydrogen storage system to be used when the light is not shining.

FIG. 1B depicts a block diagram for the integrated system for generating continuous heat when the system is not receiving sunlight. In general, the hydrogen gas stored in the hydrogen storage system is utilized by the catalytic reactor and the hydrogen fuel cell. The catalytic reactor and the hydrogen fuel cell produce heat into the thermal loop which is utilized by the heat load and electricity which is used by the heat pump to circulate fluid through the thermal loop.

### DETAILED DESCRIPTION OF THE INVENTION

Provided herein are systems for a continuous generation of a heat supply from renewable energy. The systems comprise: a hydrogen generator; a photovoltaic panel electrically connected to the hydrogen generator; and a thermal loop. The thermal loop is in thermal communication with the hydrogen generator. The thermal loop comprises a solar thermal system; a heat load, and a radiator. The integrated systems, as disclosed below, provided continuous heat generation for 24 hours, 7 days a week, without the use of non-renewable energy sources.

Each component in the system has a specific function when receiving sunlight. Generally, when the system is receiving sunlight (i.e., during the daytime with little or no cloud cover), energy from the sun causes the photovoltaic panel to produce electricity and the solar thermal system to produce thermal energy. The thermal energy from the solar thermal system heats a heat exchange fluid in the thermal loop, which is provided to a heat load. The pump utilizes electrical energy produced by the photovoltaic panel to circulate the heat exchange fluid through the thermal loop. The hydrogen generator also uses electricity from the photovoltaic panel to produce hydrogen gas, which is stored in the hydrogen storage system. Excess heat produced by the hydrogen generator may be captured by the thermal loop. Additionally, the hydrogen gas produced by the hydrogen generator may be stored in the hydrogen storage system until needed or provided to a hydrogen fuel cell or a reactor.

The integrated system comprises a photovoltaic panel to produce electricity. Preferably, the integrated system comprises a plurality of photovoltaic panels. Photovoltaic panels and methods of making and procuring photovoltaic panels are generally well known in the art. Any photovoltaic panel that produces electricity is suitable for use in the integrated systems of the present disclosure. The photovoltaic panel is electrically connected to the hydrogen generator, thus providing power to the hydrogen generator. The photovoltaic panel may also be electrically connected to the pump, thus providing power to the pump. In some embodiments, the integrated system comprises a plurality of photovoltaic panels.

The integrated system comprises a hydrogen generator. The hydrogen generator is operable to produce hydrogen gas. Hydrogen generators, and methods of making and procuring hydrogen generators, are generally known in the art. For example, the hydrogen generator may include steam methane reformers, methane pyrolysis reactors, plasma reformers, coal gasification systems, thermolysis reactors, radiolysis reactors, and other systems and methods known in the art.

Preferably, the hydrogen generator comprises an electrolyzer module. Electrolyzer modules and methods of making and procuring electrolyzer modules are generally known in the art. As will be appreciated by those having ordinary skill in the art, electrolyzers convert water into hydrogen gas and oxygen gas via electrolysis. In particular, electrolyzer modules (also referred to as electrochemical modules) suitable for use in the system of the present disclosure are described in U.S. Application No. 17/101,232 (issued as U.S. Pat. No. 11,492,711) entitled “ELECTROCHEMICAL DEVICES, MODULES, AND SYSTEMS FOR HYDROGEN GENERATION AND METHODS OF OPERATING THEREOF”, filed Nov. 23, 2020, the entire contents of which are incorporated by reference herein in their entirety. In some embodiments, the system may comprise a plurality of electrolyzer modules.

The electrolyzer module may comprise a membrane electrolyte such as a proton exchange membrane (PEM). The PEM may comprise any suitable proton exchange (e.g., hydrogen ion transport) polymer membrane, such as Nation® membrane composed of sulfonated tetrafluoroethylene based fluoropolymer-copolymer having a formula C₇HF₁₃O₅S·C₂F₄.

The electrolyzer module comprises an inlet operable to receive water from a water source or water reservoir (e.g., municipal water supply, purified water, etc.). The inlet may therefore be fluidly connected to the water source. The water may be pumped from the water source to the inlet of the electrolyzer module. Preferably, the water is purified to minimize the amount of impurities introduced into the electrolyzer module.

The electrolyzer module also comprises an outlet operable to deliver hydrogen to the system. The outlet may be fluidly connected to a dryer, a hydrogen pump, or to a hydrogen storage system. The gas flowing from the electrolyzer through the outlet consists essentially of hydrogen and water. The hydrogen flowing from the electrolyzer may have a purity of about 90% to about 99%, or more preferably about 95% to about 99% by weight. For example, the purity of the hydrogen gas may be at least about 95%, at least about 96%, at least about 97%, at least about 98%, or at least about 99% on a weight basis. The impurities of the hydrogen gas flowing from the electrolyzer module may include oxygen and water.

The electrolyzer module may further comprise power electronics. The power electronics may be formed or provided in a single assembly that connects input energy, the electrolyzer stack, and/or additional energy outputs or energy loads. The power electronics may be operable to connect to DC energy inputs, AC energy inputs, and combinations thereof. The power electronics may further be operable to connect to DC energy loads, AC energy loads, and combinations thereof. Further, the power electronics may allow for direct delivery of energy inputs to the energy loads in parallel with the operation of the energy storing electricity generator during times when those energy input sources are available. This is particularly useful when the energy inputs comprise intermittent energy sources. The power electronics may comprise a GaN inverter board, an integrated power board, control cards, a display board, and/or a DAB converter, one or more transformers, one or more rectifiers, etc.

The system may further comprise a dryer fluidly connected to a hydrogen pump and/or fluidly connected to the hydrogen generator. The dryer may be, for example, a pressure swing adsorption (PSA) system, a temperature swing adsorption (TSA) system, a hybrid PSA-TSA system, or a membrane purifier. The dryer may include one or more beds of a water-adsorbent material, such as activated carbon, silica, zeolite or alumina. The dryer may include a membrane such as a PEM electrolyte.. The inlet portion is operable to receive hydrogen from the hydrogen generator. The inlet portion of the dryer may therefore be fluidly connected to a hydrogen pump. The inlet hydrogen gas may have a purity of about 90% to about 99%. The outlet portion is operable to provide dry hydrogen to a hydrogen load, and therefore may be fluidly connected to a hydrogen load. The dryer may also comprise a second outlet comprising low pressure hydrogen, e.g., from about 1 bar to about 2 bar, or less than about 1 bar.

The system may further comprise a proton conducting hydrogen pump. The proton conducting hydrogen pump (also referred to herein as a “hydrogen pump”) may be, for example, an electrochemical pump. As used in this context, an electrochemical pump shall be understood to include a proton exchange membrane (i.e., a PEM electrolyte) disposed between an anode and a cathode. The proton exchange membrane may be any proton exchange membrane discussed herein. The hydrogen pump may generate protons moveable from the anode through the proton exchange membrane to the cathode form pressurized hydrogen. Thus, the hydrogen pump may be operable to provide pressurized hydrogen produced by the hydrogen generator to a hydrogen load. The hydrogen pump may be fluidly connected to a dryer, to the hydrogen generator, and/or to a hydrogen generation system.

In particular, hydrogen pumps suitable for use in the system of the present disclosure are described in U.S. Application No. 17/101,232 entitled “ELECTROCHEMICAL DEVICES, MODULES, AND SYSTEMS FOR HYDROGEN GENERATION AND METHODS OF OPERATING THEREOF”, filed Nov. 23, 2020, the entire contents of which are incorporated by reference herein in their entirety.

The hydrogen pump may be operable to improve the purity of the hydrogen. For example, the hydrogen flowing from the hydrogen pump may have a purity of about 98% to about 99.999%, such as from about 98% to about 99%, about 98% to about 99.9%, about 98% to about 99.99%, about 98% to about 99.999%, about 99% to about 99.999%, about 99.9% to about 99.999%, or about 99.99% to about 99.999%. The major impurities of the hydrogen flowing from the hydrogen pump may include oxygen and water.

The hydrogen generator may be operational when receiving electricity from the photovoltaic panel. At night, the hydrogen generator may be shut down to conserve electricity, or the hydrogen generator may be electrically connected to another power source to continue producing hydrogen at night. In particular, the hydrogen generator may be electrically connected to a power grid such as a regional power grid, a municipal power grid, or a micro grid, and the hydrogen generator may run when the price of electricity is low.

The integrated systems of the present disclosure comprise a thermal loop. The thermal loop comprises pipes, valves, and other instrumentation necessary to transport a heat exchange fluid to the various system components thermally connected to the thermal loop. Each system component thermally connected to the thermal loop may be connected to the thermal loop via one or more heat exchangers, such as shell and tube heat exchangers, plate heat exchangers, plate and shell heat exchangers, adiabatic wheel heat exchangers, plate fin heat exchangers, finned tube heat exchangers, pillow plate heat exchangers, phase-change heat exchangers, and other heat exchangers known in the art. Thus, the systems of the present disclosure may include one or a plurality of heat exchangers. This allows heat energy produced by system components to be transferred to a heat load. As used herein, a “heat load” is defined as a device, system, or process that requires an input of thermal energy to function. The heat load may include air heating systems, water heating systems, and other systems that require heat.

The integrated system for a continuous generation of a heat supply may use various heat exchange fluids. The heat exchange fluid is included in the thermal loop and is operable to absorb thermal energy from system components that produce heat (e.g., solar thermal system, hydrogen generator, hydrogen fuel cell, reactor, etc.) and release thermal energy to system components that absorb or release heat (e.g., the radiator, solar thermal system when acting as a radiator, etc.). Heat exchange fluids useful in the systems of the present disclosure are generally known to those having ordinary skill in the art. In some embodiments, the heat exchange fluid may be a molten salt, such as nitrate salts (e.g., lithium nitrate, sodium nitrate, potassium nitrate), chloride salts, fluoride salts, and other molten salts suitable for heat exchange known in the art. In other embodiments, the heat exchange fluid may include water, glycol (such as ethylene glycol), and combinations thereof.

The thermal loop in the integrated system is in thermal communication with the hydrogen generator. The thermal loop comprises a pump to circulate the heat exchange fluid through the thermal loop. The pump may be any pump known in the art suitable for circulating the heat exchange fluid. For example, the pump may be a positive-displacement pump, a centrifugal pump, or an axial-flow pump.

In an exemplary embodiment, the pump is a heat pump which is operable to provide additional thermal energy to the heat exchange fluid. Heat pumps and methods of making and procuring heat pumps are generally known to those having ordinary skill in the art. The heat pump functions by recirculating the heat exchange fluid through the thermal loop and further adding heat to the heat exchange fluid when necessary. The heat pump is preferably electrically powered and thus is preferably electrically connected to the photovoltaic panel and/or a hydrogen fuel cell. Alternatively or additionally, the heat pump may be electrically connected to a power grid such as a regional power grid, a municipal power grid, or a micro grid.

The thermal loop further comprises a solar thermal system. Solar thermal systems and methods of making and procuring solar thermal systems are generally known in the art. Solar thermal systems generate thermal energy using sunlight, generally by directing the sunlight using mirrors onto an absorber. The thermal energy may then be transferred to the heat exchange fluid in the thermal loop. Therefore, the solar thermal system is thermally connected to the thermal loop. Additionally, the solar thermal system may be configured to operate as a radiator when the solar thermal system is not generating heat, i.e., when the system is not receiving sunlight (e.g., at night or during periods of heavy cloud cover). This may be useful to release heat from the integrated system when the heat is not needed. In some embodiments, the integrated system comprises a plurality of solar thermal systems.

The integrated system further comprises a radiator. Radiators and methods of making and procuring radiators are generally known to those having ordinary skill in the art. The radiator functions to release thermal energy to the atmosphere and away from the integrated system as needed, such as when the heat load is not functioning. The radiator may be in thermal communication with the heat load and/or the heat pump. In some embodiments, the system comprises a plurality of radiators. Preferably the hydrogen generator is in thermal communication with the radiator either via the thermal loop or in direct thermal communication with the radiator.

The thermal loop may further comprise a reactor. The reactor may require heat and/or hydrogen in order to function, and one or both may be provided by the integrated system described herein. Additionally, the reactor may require electricity to function, which may also be provided by the fuel cell of the integrated system of the present disclosure. The reactor may be any reactor known in the art, such as a catalytic reactor, continuously stirred tank reactor, a plug flow reactor. Preferably, the reactor comprises a catalytic reactor. In an example, the catalytic reactor performs catalytic combustion of hydrogen gas produced by the hydrogen generator, which produces heat at very high efficiency.

The system may further comprise an electrical storage system. The electrical storage system may be electrically connected to the photovoltaic panel and may be capable of storing electrical energy produced by the photovoltaic panel when an excess of energy is produced. The electrical storage system may also be electrically connected to other energy sources, including renewable energy sources, non-renewable energy sources, a municipal power grid, a regional power grid, etc. The electrical storage system may supply electrical power to the integrated system as needed.

Preferably, the electricity from the photovoltaic panel powers the hydrogen generator. When the hydrogen generator is not running or if there is an over-production of electricity from the photovoltaic panel, the excess electricity generated by the photovoltaic panel may be stored in an electricity storage system. The electricity storage system may include any system for storing electricity known in the art. For example, the electricity storage system may include one or more batteries, such as lithium ion batteries.

The integrated system may further comprise a hydrogen fuel cell. The hydrogen fuel cell is operable to produce electricity by combining hydrogen and oxygen to form water. The hydrogen fuel cell generally produces heat while functioning, and thus may be in thermal communication with the thermal loop to provide cooling to the fuel cell. Hydrogen fuel cells and methods of making and procuring hydrogen fuel cells are generally well known in the art. Preferably, the hydrogen fuel cell is a proton-exchange membrane fuel cell.

The hydrogen fuel cell may be electrically connected to the hydrogen generator. The hydrogen fuel cell may also be fluidly connected to the hydrogen generator and/or the hydrogen storage system. The hydrogen fuel cell may further be used to provide electricity to a load such as a reactor or another system component requiring electricity.

In some aspects, the hydrogen fuel cell may also be operated in a shorted condition or electrically connected to an electrical heater. This allows the hydrogen fuel cell to deliver large amounts of thermal energy at very high efficiency. Thus, the hydrogen fuel cell may be flexibly used as a source of electrical energy and thermal energy as desired or required by system specifications or customer demand.

The integrated system may further comprise a hydrogen storage system. The hydrogen storage system may be fluidly connected to the hydrogen generator. The hydrogen storage system may also be fluidly connected to the hydrogen fuel cell. The hydrogen may be stored at a pressure from about 10 bar to about 800 bar; for example, about 10 bar, about 50 bar, about 100 bar, about 150 bar, about 200 bar, about 250 bar, about 300 bar, about 350 bar, 400 bar, 450 bar, 500 bar, 550 bar, 600 bar, 650 bar, about 700 bar, about 750 bar, or about 800 bar. The pressurized hydrogen may be stored at a pressure from about 10 bar to about 50 bar, about 10 bar to about 100 bar, about 10 bar to about 200 bar, about 10 bar to about 300 bar, about 10 bar to about 400 bar, about 10 bar to about 500 bar, about 10 bar to about 600 bar, about 10 bar to about 700 bar, about 10 bar to about 800 bar, about 100 bar to about 800 bar, about 200 bar to about 800 bar, about 300 bar to about 800 bar, about 400 bar to about 800 bar, about 500 bar to about 800 bar, about 600 bar to about 800 bar, about 700 bar to about 800 bar, about 300 bar to about 700 bar, or about 300 bar to about 600 bar. In some examples, the hydrogen may be stored at a pressure of about 350 bar, about 550 bar, or about 700 bar. One or more hydrogen pumps may be used to pressurize the hydrogen. Alternatively, other devices and systems to increase the pressure of hydrogen may be used, such as a compressor.

The hydrogen generator may transfer generated hydrogen gas into the hydrogen storage system. The stored hydrogen may then be transferred to the hydrogen fuel cell, to an external hydrogen load (e.g., a catalytic combustion reactor), and/or the stored hydrogen may continue to be stored for future use.

The system may further comprise a DC/DC rectifier. The DC/DC rectifier may be electrically connected to the photovoltaic panel and the hydrogen generator. The DC/DC rectifier (also referred to as a DC/DC converter) functions to convert the source of direct current from one voltage to another. Thus, the DC/DC rectifier may convert the voltage from the direct current produced by the photovoltaic panel to a different voltage compatible with the voltage required by the hydrogen generator and other components of the integrated system.

The integrated systems described herein may be operable to provide a continuous heat supply for at least 4 hours, 8 hours, 16 hours, 24 hours, 48 hours, 100 hours, 250 hours, 500 hours, 1000 hours, or greater.

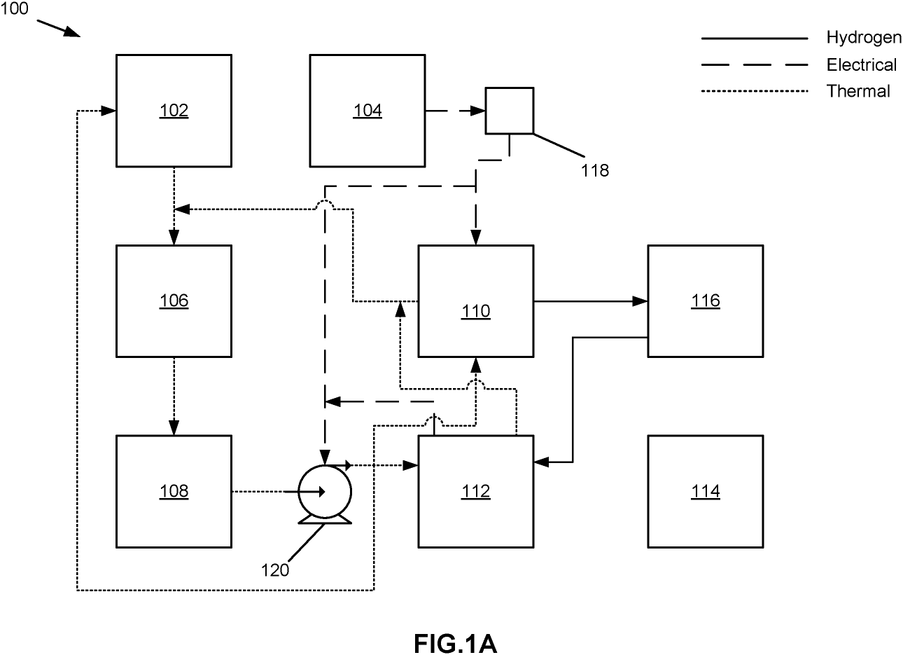

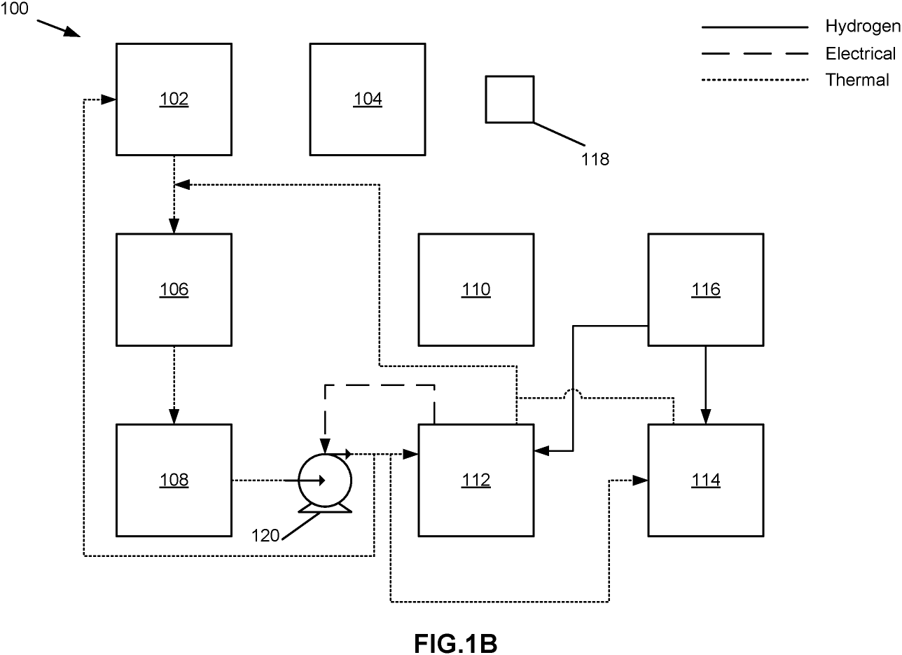

Referring now to FIG. 1A and FIG. 1B, an embodiment of an integrated system for continuous generation of a heat supply is shown. FIG. 1A is a block diagram of the integrated system 100 for a continuous generation of a heat supply from renewable energy when the system is receiving sunlight. FIG. 1B is a block diagram of the integrated system 100 for a continuous generation of a heat supply from renewable energy when the system is not receiving sunlight. In each figure, fluid connections for transporting hydrogen are shown by a solid line, electrical connections for transferring electricity are shown by a dashed line, and thermal connections for transferring thermal energy (i.e., via a heat exchange fluid) are shown by a dotted line.

It should be noted that certain connections are shown in FIG. 1A that are not shown in FIG. 1B, and vice versa. This is done for the sake of simplicity and to show the different system functions when the system is receiving sunlight (FIG. 1A) versus when the system is not receiving sunlight (FIG. 1B). Those having skill in the art will appreciate that the connections which are shown in FIG. 1A but are not shown in FIG. 1B are still present in the system 100 of FIG. 1B but are not in use when the system 100 is receiving sunlight. Similarly, the connections which are shown in FIG. 1B but are not shown in FIG. 1A are still present in the system 100 of FIG. 1A but are not in use when the system 100 is not receiving sunlight.

With respect to FIG. 1A, the embodiment of the integrated system 100 comprises an electrolyzer module 110, a photovoltaic panel 104, and a thermal loop. The photovoltaic panel 104 is electrically connected to a DC/DC rectifier 118 to condition the power supplied to the electrolyzer module 110 and to the other electrically operated system components; thus, the electrolyzer module 110 is electrically connected to the DC/DC rectifier 118. The system further includes a reactor 114, which is not in use when the system 100 is receiving sunlight. The system also comprises a hydrogen fuel cell 112 electrically connected to a heat pump 120 and the electrolyzer module 110.

The thermal loop comprises a solar thermal system 102, a heat load 106, a radiator 108, and a heat pump 120. A heat exchange fluid is used to transfer thermal energy between each component of the thermal loop, and is driven by the heat pump 120. The heat exchange fluid collects thermal energy from the solar thermal system 102 and optionally the hydrogen fuel cell 112, and releases thermal energy at the heat load 106 and at the radiator 108.

The electrolyzer module 110 is fluidly connected to a hydrogen storage system 116, which stores hydrogen generated by the electrolyzer module 110. The hydrogen storage system 116 is also fluidly connected to the hydrogen fuel cell 112 and may deliver hydrogen to the hydrogen fuel cell 112 to produce electricity. The hydrogen fuel cell 112 generates heat when operational, and thus is in thermal communication with the thermal loop to provide heat to the heat exchange fluid. The hydrogen fuel cell 112 is also operable to produce electricity, and thus is electrically connected to the heat pump 120 and the electrolyzer module 110.

With respect to FIG. 2, the integrated system 100 functions differently when the system is not receiving sunlight. Here, the photovoltaic panel 104 is unable to produce electricity because the system is not receiving sunlight, and therefore the electrolyzer module 110 is not functioning. Additionally, the solar thermal system 102 is not able to produce thermal energy, but instead acts as a radiator to release thermal energy to the ambient environment. The stored hydrogen gas is introduced into the hydrogen fuel cell 112 to produce electricity, which powers the heat pump 120. Additionally, the stored hydrogen is provided to the reactor 114; thus, the hydrogen storage system 116 is fluidly connected to the reactor.

The hydrogen fuel cell 112 further produces thermal energy, which is captured by the heat exchange fluid in the thermal loop. The thermal loop continues to provide heat to the heat load 106 and release heat using the radiator 108 and, now, the solar thermal system 102. The thermal loop is also in thermal communication with the reactor 114, which provides additional thermal energy to the thermal loop thereby creating a constant supply of heat for the heat load 106.

Further provided herein are methods of producing a continuous heat supply from renewable energy sources. The methods may be accomplished using any of the systems of the present disclosure. The methods generally include producing thermal energy via a solar thermal system as described herein; generating hydrogen in a hydrogen generator as described herein; producing thermal energy by combustion of the generated hydrogen; and providing the produced thermal energy to a heat load.

The combustion of the produced hydrogen may be accomplished in a reactor, such as in a catalytic combustion reactor. The combustion of the produced hydrogen may be performed on-demand when an input of thermal energy is needed, continuously, or only when the system is not receiving sunlight.

The thermal energy produced by the solar thermal system may only produced when the solar thermal system is receiving sunlight. When the solar thermal system is not receiving sunlight, the methods may further include releasing the produced thermal energy via a radiator or via the solar thermal system, which may act as a radiator.

The produced thermal energy may be provided to the heat load via a heat exchange fluid circulating in a thermal loop as described herein. The heat exchange fluid may be any heat exchange fluid described hereinabove.

The methods may further comprise storing the produced hydrogen in a hydrogen storage system as described herein. The stored hydrogen may be used to produce electricity and/or thermal energy using a hydrogen fuel cell as described herein.

### DEFINITIONS

When introducing elements of the embodiments described herein, the articles “a”, “an”, “the” and “said” are intended to mean that there are one or more of the elements. The terms “comprising”, “including” and “having” are intended to be inclusive and mean that there may be additional elements other than the listed elements.

As used herein, a “fluid” connection is a connection that allows for or facilitates the transfer of fluids including liquids and gases. Non-limiting examples of fluid connections include pipes, manifolds, ducts, valves, hoses, couplings, tubes, etc. Components which are in “fluid communication” with one another are understood to have one or more fluid connections with one another.

As used herein, an “electrical” connection is a connection that allows for or facilitates the transfer of electricity. Non-limiting examples of electrical connections include wires, cables, power lines, breakers, transformers, converters, rectifiers, switches, etc. Components which are in “electrical communication” with one another are understood to have one or more electrical connections with one another.

As used herein, a “thermal” connection is a connection that allows for or facilitates the transfer of heat from one medium to another. Thermal connections may include heat exchangers, such as shell and tube heat exchangers, plate heat exchangers, plate and shell heat exchangers, adiabatic wheel heat exchangers, plate fin heat exchangers, finned tube heat exchangers, pillow plate heat exchangers, phase-change heat exchangers, and other heat exchangers known in the art. System components which are “thermally connected” to one another are able to transfer thermal energy to/from each other via, e.g., a heat exchanger. Components which are in “thermal communication” with one another are understood to have one or more thermal connections with one another.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or,” and the term “and” should generally be understood to mean “and/or.”

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as including any deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples or exemplary language (“e.g.,” “such as,” or the like) is intended merely to better illuminate the embodiments and does not pose a limitation on the scope of those embodiments. No language in the specification should be construed as indicating any unclaimed element as essential to the practice of the disclosed embodiments.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the scope of the disclosure.

What is claimed is:

1. A system for generating a continuous heat supply from renewable energy comprising:
a hydrogen generator to be electrically connected to a photovoltaic panel and to be thermally connected to a thermal loop, the thermal loop including:
a solar thermal system,
a heat load, and
a radiator.

2. The system of claim 1, wherein the solar thermal system, the heat load, and the radiator are in thermal communication with one another via a heat exchange fluid.

3. The system of claim 2, wherein the heat exchange fluid is a molten salt.

4. The system of claim 2, wherein the heat exchange fluid is glycol.

5. The system of claim 1, further comprising a hydrogen fuel cell electrically connected to the hydrogen generator.

6. The system of claim 1, further comprising a DC/DC rectifier electrically connected to the photovoltaic panel and the hydrogen generator.

7. The system of claim 1, further comprising a hydrogen storage system fluidly connected to the hydrogen generator.

8. The system of claim 1, wherein the hydrogen generator comprises a proton exchange membrane (PEM) electrolyzer.

9. The system of claim 1, wherein the thermal loop further includes a pump.

10. The system of claim 9, wherein the pump is a heat pump.

11. The system of claim 10, wherein the heat pump is electrically connected to the photovoltaic panel.

12. The system of claim 1, wherein the thermal loop further comprises a reactor.

13. The system of claim 12, wherein the reactor comprises a catalytic combustion reactor.

14. The system of claim 1, wherein the solar thermal system is configured to operate as a radiator when it is not generating heat.

15. The system of claim 1, further comprising an electricity storage system electrically connected to the photovoltaic panel.

16. A method of producing a continuous heat supply from renewable energy comprising:
producing thermal energy via a solar thermal system;
generating hydrogen in a hydrogen generator;
producing thermal energy by combusting the generated hydrogen; and
providing the produced thermal energy to a heat load.

17. The method of claim 16, wherein the thermal energy produced by the solar thermal system is only produced when sunlight is received by the solar thermal system.

18. The method of claim 16, wherein the thermal energy produced by combustion of the generated hydrogen is only produced when sunlight is not received by the system.

19. The method of claim 16, wherein the thermal energy is provided to the heat load via a heat exchange fluid.

20. The method of claim 16, further comprising releasing the produced thermal energy via a radiator or via the solar thermal system when the system is not receiving sunlight.
